(19) United States
(12) Patent Application Publication
(10) Pub. No.: US 2025/0029465 A1
(43) Pub. Date: Jan. 23, 2025

(54) FALL DETECTION METHOD, ELECTRONIC DEVICE, AND STORAGE MEDIUM

(71) Applicant: Luxshare Precision Industry Company Limited, SHENZHEN (CN)

(72) Inventor: GUANHSIUNG WANG, SHENZHEN (CN)

(73) Assignee: Luxshare Precision Industry Company Limited, SHENZHEN (CN)

(21) Appl. No.: 18/624,618

(22) Filed: Apr. 2, 2024

(30) Foreign Application Priority Data
Jul. 18, 2023 (CN) 202310883494.1

(51) Int. Cl. G08B 21/04; G08B 3/10

(52) U.S. Cl. CPC G08B 21/043; G08B 3/10; G08B 21/0492

(57) ABSTRACT

A fall detection method is applied to a fall detection system including a thermal imaging unit, a radio frequency transceiver, and a wireless access point. The method includes the following steps: a first speed of a to-be-detected target is determined according to an infrared thermal image of the to-be-detected target captured by the thermal imaging unit within preset time; network packet throughput and a second speed of the to-be-detected target are determined according to wireless network packet data transmitted by the wireless access point and collected by the radio frequency transceiver within the preset time; and a detection result of a fall state of the to-be-detected target is generated and determined according to the first speed, the second speed, and the network packet throughput.

### CROSS-REFERENCE TO RELATED APPLICATION(S)

This application claims the priority to Chinese Patent Application No. CN202310883494.1, filed on Jul. 18, 2023, the disclosure of which is incorporated herein by reference in its entirety.

### TECHNICAL FIELD

The present application relates to the field of fall recognition technology and, for example, to a fall detection method and apparatus, an electronic device, and a storage medium.

### BACKGROUND

With people's increasing attention to the life and health problems of the elderly, an indoor human fall detection has become a research hotspot. For current fall detection methods, indoor human fall detections are implemented based on techniques such as infrared thermal imaging or channel state information (CSI). However, the preceding methods have the problems below.
(1) A fall detection method based on the infrared thermal imaging technology is easily affected by a change in ambient temperature and illumination transformation, leading to a relatively low accuracy of a human fall detection.
(2) A fall detection method based on the CSI technology is easily affected by co-frequency interference. If strong WIFI co-channel signal interference exists indoors, the acquired WIFI CSI information may be distorted, thereby leading to a relatively low accuracy of a human fall detection.
(3) A hardware device such as a barometer, a sensor, and a millimeter-wave radar is required to implement a fall detection, resulting in a relatively high cost.

### SUMMARY

Embodiments of the present application provide a fall detection method and apparatus, an electronic device, and a storage medium. In this case, a first speed of a to-be-detected target is determined according to an infrared thermal image captured by a thermal imaging unit; a second speed of the to-be-detected target and network packet throughput are determined according to wireless network packet data received by a radio frequency transceiver; and thus a detection result of a fall state of the to-be-detected target is determined comprehensively according to the first speed, the second speed, and the network packet throughput, improving the accuracy of the fall detection result and reducing the cost of a fall detection.

According to an aspect of the embodiment of the present application, a fall detection method is provided. The fall detection method is applied to a fall detection system. The fall detection system includes a thermal imaging unit, a radio frequency (RF) transceiver, and a wireless access point (AP). The method includes the steps below.

A first speed of the to-be-detected target is determined according to an infrared thermal image of a to-be-detected target within preset duration captured by the thermal imaging unit.

Network packet throughput and a second speed of the to-be-detected target are determined according to wireless network packet data transmitted by the wireless access point and collected by the radio frequency transceiver within the preset duration.

A detection result of a fall state of the to-be-detected target is generated and determined according to the first speed, the second speed, and the network packet throughput.

According to another aspect of the present application, a fall detection apparatus is provided. The fall detection apparatus is applied to a fall detection system. The fall detection system includes a thermal imaging unit, a radio frequency transceiver, and a wireless access point. The apparatus includes a first speed determination module, a network packet throughput and second speed determination module, and a fall detection module.

The first speed determination module is configured to determine a first speed of a to-be-detected target according to an infrared thermal image of the to-be-detected target captured by the thermal imaging unit within preset duration.

The network packet throughput and second speed determination module is configured to determine network packet throughput and a second speed of the to-be-detected target according to wireless network packet data transmitted by the wireless access point and collected by the radio frequency transceiver within the preset duration.

The fall detection module is configured to generate and determine a detection result of a fall state of the to-be-detected target according to the first speed, the second speed, and the network packet throughput.

According to another aspect of the present application, an electronic device is provided. The electronic device includes at least one processor and a memory communicatively connected to the at least one processor.

The memory stores a computer program executable by the at least one processor. The computer program is executed by the at least one processor to cause the at least one processor to perform the fall detection method according to any embodiment of the present application.

According to another aspect of the present application, a computer-readable storage medium is provided. The computer-readable storage medium stores a computer instruction. When the computer instruction is executed by a processor, the fall detection method according to any embodiment of the present application is performed.

### BRIEF DESCRIPTION OF DRAWINGS

To illustrate technical solutions in embodiments of the present application more clearly, the drawings used in description of the embodiments are described below. The drawings described below merely illustrate part of embodiments of the present application.

FIG. 1 is a flowchart of a fall detection method according to an embodiment of the present application.

FIG. 2 is a flowchart of a fall detection method according to another embodiment of the present application.

FIG. 3 is an exemplary diagram of a fall detection system according to another embodiment of the present application.

FIG. 4 is an exemplary flowchart of a fall detection method according to another embodiment of the present application.

FIG. 5 is a flowchart of a fall detection method according to another embodiment of the present application.

FIG. 6 is a diagram of an infrared thermal image according to another embodiment of the present application.

FIG. 7 is a diagram of a center point of the infrared thermal image according to another embodiment of the present application.

FIG. 8 is a diagram of a normal detection according to another embodiment of the present application.

FIG. 9 is a diagram of a fall detection according to another embodiment of the present application.

FIG. 10 is a diagram of another fall detection according to another embodiment of the present application.

FIG. 11 is a flowchart of another fall detection method according to another embodiment of the present application.

FIG. 12 is a structural diagram of a fall detection apparatus according to another embodiment of the present application.

FIG. 13 is a structural diagram of an electronic device for implementing a fall detection method according to another embodiment of the present application.

FIG. 14 is a structural diagram of a fall detection device according to another embodiment of the present application.

### DETAILED DESCRIPTION

For a better understanding of the solutions of the present application by those skilled in the art, the technical solutions in embodiments of the present application are described clearly and completely below in conjunction with the drawings in embodiments of the present application. Apparently, the embodiments described below are merely part, not all, of embodiments of the present application.

It is to be noted that the terms “first”, “second” and the like in the description, claims and drawings of the present disclosure are used to distinguish between similar objects and are not necessarily used to describe a particular order or sequence. It is to be understood that the data used in this way is interchangeable where appropriate so that embodiments of the present application described herein may also be implemented in a sequence not illustrated or described herein. Additionally, terms “including” and “having” or any variations thereof are intended to encompass a non-exclusive inclusion. For example, a process, method, system, product or device that includes a series of steps or units not only includes the expressly listed steps or units but may also include other steps or units that are not expressly listed or are inherent to such a process, method, product or device.

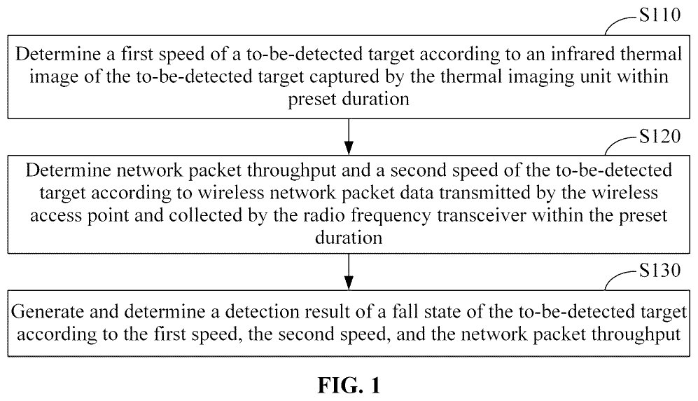

FIG. 1 is a flowchart of a fall detection method according to an embodiment of the present application. This embodiment is applicable to the case of a human fall detection. The method may be performed by a fall detection apparatus. The fall detection apparatus may be implemented by software and/or hardware and may be disposed in an electronic device, such as a fall detection device. As shown in FIG. 1, a fall detection method is provided in the preceding embodiment. The fall detection method is applied to a fall detection system. The fall detection system includes a thermal imaging unit, a radio frequency transceiver, and a wireless access point. The method specifically includes the steps below.

In S110, a first speed of a to-be-detected target is determined according to an infrared thermal image of the to-be-detected target captured by the thermal imaging unit within preset duration.

The to-be-detected target may be understood as a target whose fall state is to be detected. The to-be-detected target may include but is not limited to an elderly person and a child. The to-be-detected target may be located in a certain space such as a room, an office, and a garage. The thermal imaging unit may refer to a functional unit for photosensitive imaging of infrared rays emitted by an object. The thermal imaging unit may include, for example, various types of thermal imagers and thermal imaging cameras. The infrared thermal image may refer to an image formed by the thermal radiation energy emitted by the object received and recorded by the thermal imaging unit. Different objects or different parts of the same object usually have different thermal radiation properties. The first speed may be understood as a speed of the to-be-detected target determined by using the infrared thermal image of the to-be-detected target.

The preset duration may refer to the preconfigured duration for collecting the information of the to-be-detected target. The preset duration may be set to, for example, 2 seconds or 3 seconds, which is not limited in this embodiment of the present application.

In this embodiment of the present application, the thermal imaging unit may be called within the preset duration to capture the infrared thermal image of the to-be-detected target. Moreover, the first speed of the to-be-detected target is determined according to the infrared thermal image. Manners of determining the first speed of the to-be-detected target according to the infrared thermal image may include but are not limited to the following: The captured infrared thermal image may be input into a trained deep learning network model, and an output result of the model is taken as the first speed of the to-be-detected target; and the captured infrared thermal image may be compared with a pre-stored standard infrared thermal image, a center point of a human thermal region in the infrared thermal image is calibrated, and then the first speed of the to-be-detected target is determined according to a movement distance of the center point within the preset duration.

In S120, network packet throughput and a second speed of the to-be-detected target are determined according to wireless network packet data transmitted by the wireless access point and collected by the radio frequency transceiver within the preset duration.

The wireless AP may refer to a device for sending the wireless network packet data. A wireless access point may include, for example, a computer device equipped with a wireless network card, an intelligent terminal having a wireless communication function, or a wireless AP device in another type. One or more wireless APs may be provided. The RF transceiver may refer to a functional unit for transceiving and processing the wireless network packet data. The RF transceiver may include functional units such as an RF front-end circuit, an RF transceiver circuit, and an RF processor. One or more RF transceivers may be provided. The wireless network packet data may refer to data sent by the wireless AP and received by the RF transceiver. The wireless network packet data may include, for example, scattered electric field data, received electric field data, and channel state information (CSI). The network packet throughput may refer to a data amount of the wireless network packet data received by the RF transceiver within certain duration. The second speed may be understood as a speed of the to-be-detected target determined by using the wireless network packet data.

In this embodiment of the present application, the RF transceiver may be called to continuously collect the wireless network packet data sent by the wireless AP within the preset duration. The data amount of the wireless network packet data is taken as the network packet throughput. The second speed of the to-be-detected target is determined according to the wireless network packet data. A manner of determining the second speed of the to-be-detected target according to the wireless network packet data may be as follows: The feature information related to the speed of the to-be-detected target may be extracted from the wireless network packet data first, then the feature information is input into the trained deep learning network model, and the second speed of the to-be-detected target is determined according to an output result of the model. Another manner of determining the second speed of the to-be-detected target according to the wireless network packet data may be as follows: An autocorrelation function (ACF) of a power response of the CSI is determined according to the wireless network packet data; and then the second speed of the to-be-detected target is determined according to a preconfigured correspondence between the autocorrelation function and the second speed, for example, according to the position of a first local valley value of the autocorrelation function of the power response of the CSI.

In S130, a detection result of a fall state of the to-be-detected target is generated and determined according to the first speed, the second speed, and the network packet throughput.

In this embodiment of the present application, when the to-be-detected target is in the fall state, the network packet throughput of the wireless network packet data received by the RF transceiver may vary from low to high. Therefore, the fall detection result of the to-be-detected target may be determined comprehensively according to the first speed, the second speed, and the network packet throughput. For example, if the first speed and the second speed are each greater than a preconfigured maximum speed threshold of the to-be-detected target, and if the network packet throughput of the wireless network packet data collected by the radio frequency transceiver within the preset duration varies from low to high, a detection result that the to-be-detected target is in the fall state will be determined. When the detection result that the to-be-detected target is in the fall state is determined, devices such as a buzzer and a display screen may be triggered to sound an alarm and display send alarm prompt information such as warning words to prompt the occurrence of a fall event. If the first speed and/or the second speed is less than the preconfigured maximum speed threshold of the to-be-detected target, and if the network packet throughput of the wireless network packet data collected by the radio frequency transceiver within the preset duration varies from low to high, a detection result that the to-be-detected target is in a sitting or squatting state, that is, a non-fall state, will be determined.

For technical solutions in this embodiment of the present application, the infrared thermal image of the to-be-detected target within the preset duration is captured according to the thermal imaging unit, and the first speed of the to-be-detected target is determined according to the infrared thermal image; the wireless network packet data transmitted by the wireless access point within the preset duration is collected according to the radio frequency transceiver, and the network packet throughput and the second speed of the to-be-detected target are determined according to the wireless network packet data; and the detection result of the fall state of the to-be-detected target is generated and determined according to the first speed, the second speed, and the network packet throughput. In this embodiment of the present application, the first speed of the to-be-detected target is determined according to the infrared thermal image. The network packet throughput and the second speed of the to-be-detected target are determined according to the wireless network packet data. The fall detection result of the to-be-detected target is then determined comprehensively according to the first speed, the second speed, and the network packet throughput, improving the accuracy of the fall detection result and reducing the cost of a fall detection.

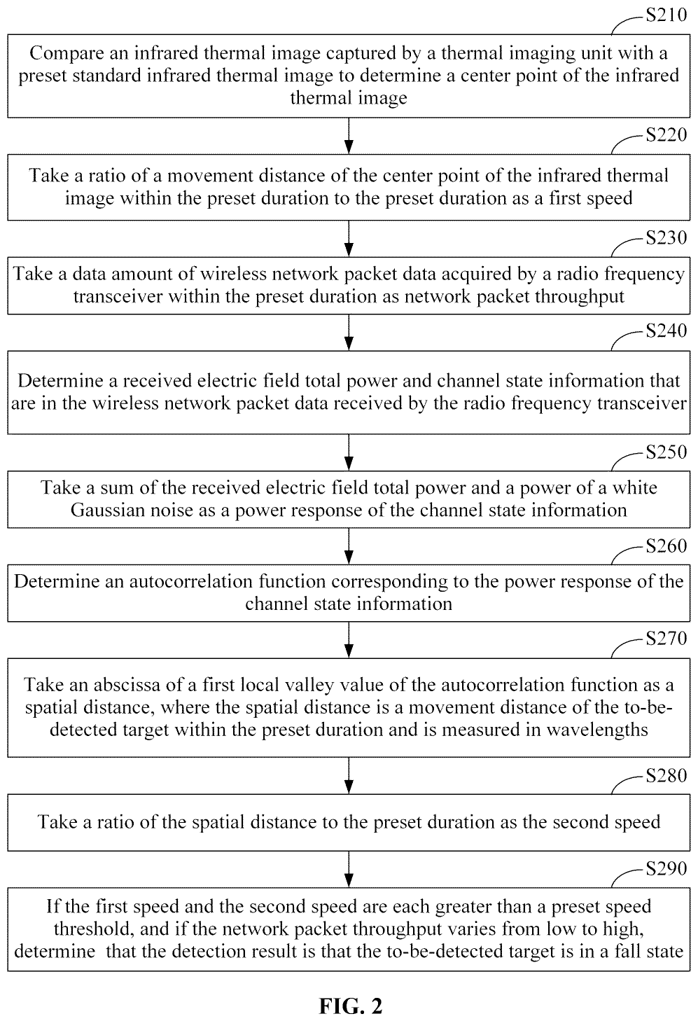

FIG. 2 is a flowchart of a fall detection method according to another embodiment of the present application. This embodiment is an optimization and expansion of the preceding embodiment and can be combined with each optional technical solution in the preceding embodiment. As shown in FIG. 2, the fall detection method according to the embodiment specifically includes the steps below.

In S210, an infrared thermal image captured by a thermal imaging unit is compared with a preset standard infrared thermal image to determine a center point of the infrared thermal image.

The preset standard infrared thermal image may be a standard infrared thermal image pre-captured and stored for a to-be-detected target. The preset standard infrared thermal image may be used for calibrating the center point of the captured infrared thermal image of the to-be-detected target. The preset standard infrared thermal image may be pre-stored in positions such as various storage devices and a database of a local or remote server. The center point may include, for example, an intersection point of two diagonal lines of the infrared thermal image, the chest of the to-be-detected target in the infrared thermal image, or the abdomen of the to-be-detected target in the infrared thermal image.

In this embodiment of the present application, the thermal imaging unit may be called to capture a plurality of infrared thermal images of the to-be-detected target within preset duration (for example, not limited to 2 seconds or 3 seconds. Because the temperature of the to-be-detected target is higher than ambient temperature, an edge of the collected infrared thermal image may be eliminated, with a rectangular region containing only a red high-temperature thermal region of the to-be-detected target reserved. Then the processed infrared thermal image is compared with the preconfigured preset standard infrared thermal image. The center point of the infrared thermal image is then calibrated. The center point may include, but is not limited to, an intersection point of two diagonal lines of the infrared thermal image, the chest of the to-be-detected target in the infrared thermal image, or the abdomen of the to-be-detected target in the infrared thermal image. The preset standard infrared thermal image may be located in storage positions such as various storage devices and a database of a local or remote server. This is not limited in this embodiment of the present application.

In S220, a ratio of a movement distance of the center point of the infrared thermal image within the preset duration to the preset duration is taken as a first speed.

In this embodiment of the present application, a first movement speed of the to-be-detected target may be determined by using the movement distance of the center point of the infrared thermal image collected within the preset duration. That is, the ratio of the movement distance of the center point of the infrared thermal image within the preset duration to the preset duration is taken as the first speed.

In S230, a data amount of wireless network packet data acquired by a radio frequency transceiver within the preset duration is taken as network packet throughput.

In this embodiment of the present application, the RF transceiver may be called to continuously collect the wireless network packet data sent by the wireless AP within the preset duration. The data amount of the wireless network packet data is taken as the network packet throughput. It is to be understood that if the to-be-detected target stays in the same state within the preset duration, the acquired network packet throughput may be unchanged basically. If the to-be-detected target is in, for example, a sitting, squatting or fall state within the preset duration, the acquired network packet throughput may vary from low to high. Therefore, a change in the network packet throughput within the preset duration may be used for assisting in determining a state of the to-be-detected target.

In S240, a received electric field total power and channel state information that are in the wireless network packet data received by the radio frequency transceiver are determined.

The channel state information (CSI) may refer to a channel feature used for estimating a communication link. CSI may describe the attenuation information of a signal in the transmission process, for example, the information such as signal scattering, environmental attenuation, and distance attenuation.

In this embodiment of the present application, the received electric field total power and the channel state information may be extracted from the wireless network packet data received by the RF transceiver. The received electric field total power may be expressed as a square of the amplitude of a scattered electric field. The CSI may be expressed as a ratio of sent signals of the wireless AP to received signals of the RF transceiver.

In S250, a sum of the received electric field total power and a power of a white Gaussian noise is taken as a power response of the channel state information.

In this embodiment of the present application, the power response of the CSI may be determined as the sum of the received electric field total power and the power of the white Gaussian noise. The white Gaussian noise follows a Gaussian distribution with zero mean and constant variance.

In S260, an autocorrelation function corresponding to the power response of the channel state information is determined.

The autocorrelation function (ACF) may refer to the cross-correlation of one signal at different time points. The autocorrelation function may be used for characterizing the similarity between the replica signal and the original signal after a delay, similar to reflection, refraction, and other conditions, of a signal.

In this embodiment of the present application, it is assumed that the power response of the CSI is P(t,f). Then the corresponding ACF may be expressed as below.

$$A C \{ P ( t , f ) \} = cov [ P ( t , f ) , P ( t - τ , f ) ] \qquad ( 1 )$$

AC{•} denotes the autocorrelation function (ACF) of the power response P(t,f) of the CSI. cov[•] denotes convolution operation. τ denotes a time delay. t denotes time. f denotes center frequency.

On the basis of the preceding embodiment of the present application, the autocorrelation function of the power response of the CSI may be expressed by a formula as below.

$$ℤψ ( t ) = \sum \text{?} ( Ω \text{?} {ℤ}^{2} E \text{?} + {Ω}_{2} ℤ E \text{?} ) \qquad ( 2 )$$

$$\text{?} \text{indicates text missing or illegible when filed}$$

[symbol]

Ψ(t) denotes the autocorrelation function corresponding to the power response of the channel state information. t denotes the preset duration. Ω₁ and Ω₂ denote scale factors. E_{jξ} denotes a scattered electric field of a j-th scatterer received by the fall detection system in x-axis, y-axis and z-axis directions. [symbol] E_{jξ} denotes an autocorrelation function corresponding to the scattered electric field.

In S270, an abscissa of a first local valley value of the autocorrelation function is taken as a spatial distance. The spatial distance is a movement distance of the to-be-detected target within the preset duration. The spatial distance is measured in wavelengths.

The first local valley value may refer to the first local minimum value (valley value) of the autocorrelation function. The spatial distance may refer to the movement distance of the to-be-detected target within the preset duration. Moreover, the spatial distance is measured in wavelengths and may be a function of wavelengths and wavenumbers. Therefore, the spatial distance is related to a second speed.

In this embodiment of the present application, the movement distance of the to-be-detected target within the preset duration may be taken as the spatial distance. The spatial distance is measured in wavelengths and is a function of wavelengths and wavenumbers. Therefore, the spatial distance is related to the second speed. The spatial distance may be determined by the abscissa corresponding to the first local valley value of the autocorrelation function of the power response of the CSI.

In S280, a ratio of the spatial distance to the preset duration is taken as the second speed.

In S290, if the first speed and the second speed are each greater than a preset speed threshold, and if the network packet throughput varies from low to high, a detection result that the to-be-detected target is in a fall state will be determined.

The preset speed threshold may refer to a preconfigured speed threshold of the to-be-detected target and may be set to, for example, 0.8 meters per second or 1 meter per second.

In this embodiment of the present application, the fall detection result of the to-be-detected target may be determined in combination within the first speed, the second speed, and the network packet throughput. That is, if the first speed and the second speed are each greater than the preconfigured preset speed threshold, and if the network packet throughput of the wireless network packet data collected by the radio frequency transceiver within the preset duration varies from low to high, the detection result that the to-be-detected target is in the fall state will be determined. If the first speed and/or the second speed is less than the preconfigured preset speed threshold, and if the network packet throughput of the wireless network packet data collected by the radio frequency transceiver within the preset duration varies from low to high, a detection result that the to-be-detected target is in a sitting or squatting state will be determined.

On the basis of the preceding embodiment of the present application, the fall detection method according to the preceding embodiment also includes the step below.

If the first speed and the second speed are each greater than the preset speed threshold, and if the network packet throughput does not vary from low to high, the preset speed threshold will be corrected.

In this embodiment of the present application, when the first speed and the second speed are each greater than the preset speed threshold, and when the network packet throughput does not vary from low to high, it indicates that the preset speed threshold previously preconfigured is no longer accurate. In this case, the movement speed of the to-be-detected target needs to be re-observed so as to correct the preset speed threshold.

On the basis of the preceding embodiment of the present application, the fall detection method according to the preceding embodiment also includes the step below.

When the detection result is that the to-be-detected target is in the fall state, a buzzer is controlled to sound an alarm.

In this embodiment of the present application, when the detection result that the to-be-detected target is in the fall state is determined, an electronic device may control the buzzer to sound an alarm to prompt the occurrence of a fall event. It is to be noted that when the detection result is that the to-be-detected target is in the fall state, it is merely an example that the buzzer is controlled to sound an alarm. In a practical application, alarm modes such as triggering a warning light and displaying warning words on a screen may also be selected, which is not limited in this embodiment of the present application.

For technical solutions in this embodiment of the present application, the infrared thermal image captured by the thermal imaging unit is compared with the preset standard infrared thermal image to determine the center point of the infrared thermal image; the ratio of the movement distance of the center point of the infrared thermal image within the preset duration to the preset duration is taken as the first speed; the data amount of the wireless network packet data acquired by the radio frequency transceiver within the preset duration is taken as the network packet throughput; the received electric field total power and the channel state information that are in the wireless network packet data received by the radio frequency transceiver are determined; the sum of the received electric field total power and the power of the white Gaussian noise is taken as the power response of the channel state information; the autocorrelation function corresponding to the power response of the channel state information is determined; the abscissa of the first local valley value of the autocorrelation function is taken as the spatial distance, where the spatial distance is the movement distance of the to-be-detected target within the preset duration, and the spatial distance is measured in wavelengths; the ratio of the spatial distance to the preset duration is taken as the second speed; and if the first speed and the second speed are each greater than the preset speed threshold, and if the network packet throughput varies from low to high, the detection result that the to-be-detected target is in the fall state will be determined. In this embodiment of the present application, the first speed of the to-be-detected target is determined according to the movement distance of the center point of the infrared thermal image. The network packet throughput is determined according to the wireless network packet data and the second speed of the to-be-detected target is determined according to the autocorrelation function of the power response of the CSI. The fall detection result of the to-be-detected target is determined comprehensively according to the first speed, the second speed, and the network packet throughput, improving the accuracy of the fall detection result and reducing the cost of a fall detection.

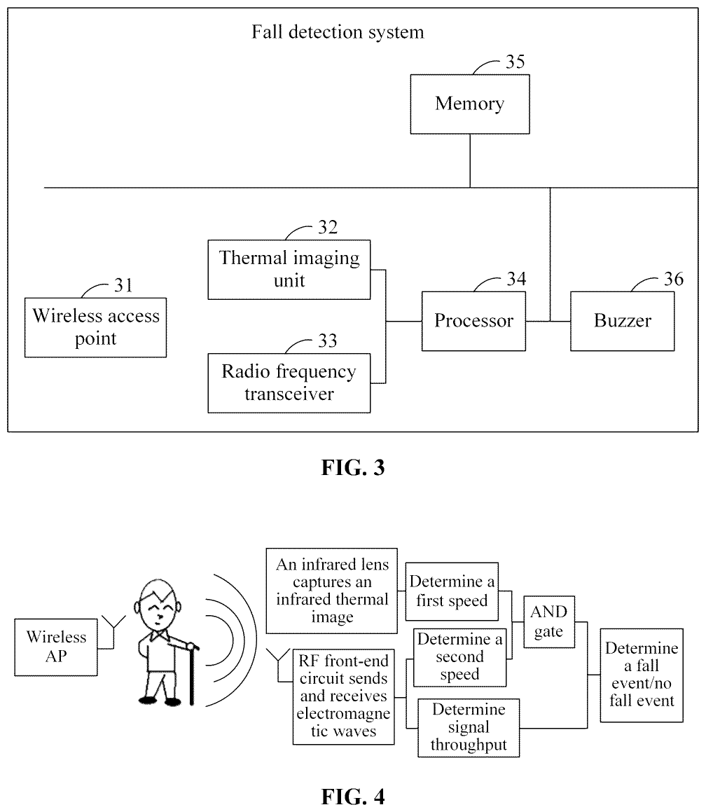

FIG. 3 is an exemplary diagram of a fall detection system according to another embodiment of the present application. As shown in FIG. 3, the fall detection system includes a wireless access point 31, a thermal imaging unit 32, a radio frequency transceiver 33, a processor 34, a memory 35, and a buzzer 36.

The wireless access point 31 is configured to emit wireless network packet data.

The thermal imaging unit 32 is configured to capture an infrared thermal image of a to-be-detected target and send the infrared thermal image to a processor.

The radio frequency transceiver 33 is configured to collect the wireless network packet data transmitted by the wireless access point and send the wireless network packet data to the processor.

The processor 34 is configured to receive the infrared thermal image, to determine a first speed of the to-be-detected target according to the infrared thermal image, to determine network packet throughput and a second speed of the to-be-detected target according to the wireless network packet data, and to generate and determine a detection result of a fall state of the to-be-detected target according to the first speed, the second speed, and the network packet throughput.

The memory 35 is configured to store a preset standard infrared thermal image of the to-be-detected target.

The buzzer 36 is configured to sound an alarm when the detection result is that the to-be-detected target is in the fall state.

Based on the preceding fall detection system, FIG. 4 is an exemplary flowchart of a fall detection method according to the embodiment of the present application. As shown in FIG. 4, the fall detection method mainly includes the following steps: (1) The infrared thermal image of the to-be-detected target is captured by an infrared lens, and the first speed of the to-be-detected target is determined according to the infrared thermal image; (2) An RF front-end circuit sends and receives electromagnetic waves and determines the second speed and the network packet throughput according to the sent and received electromagnetic waves; (3) It is generated and determined according to the first speed, the second speed, and the network packet throughput whether a fall event occurs.

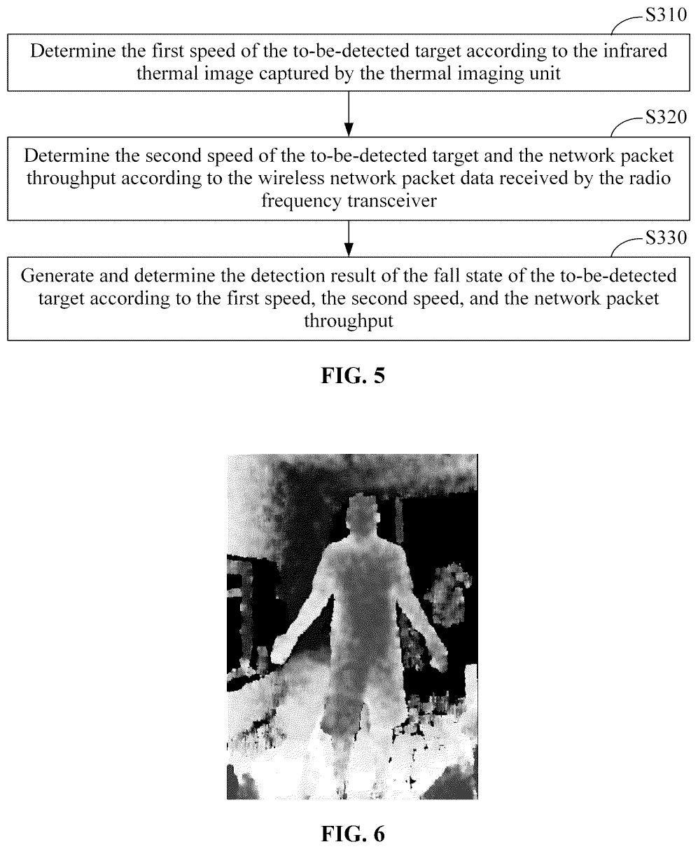

Based on the preceding fall detection system, FIG. 5 is a flowchart of a fall detection method according to the embodiment of the present application. On the basis of the preceding embodiments, this embodiment provides an implementation of a fall detection method. In this case, the first speed of the to-be-detected target is determined according to the infrared thermal image captured by the thermal imaging unit; the second speed and the network packet throughput are determined according to wireless network packet data received by the radio frequency transceiver; and thus the detection result of the fall state of the to-be-detected target is generated and determined according to the first speed, the second speed, and the network packet throughput.

As shown in FIG. 5, the fall detection method according to the embodiment of the present application specifically includes the steps below.

In S310, the first speed of the to-be-detected target is determined according to the infrared thermal image captured by the thermal imaging unit.

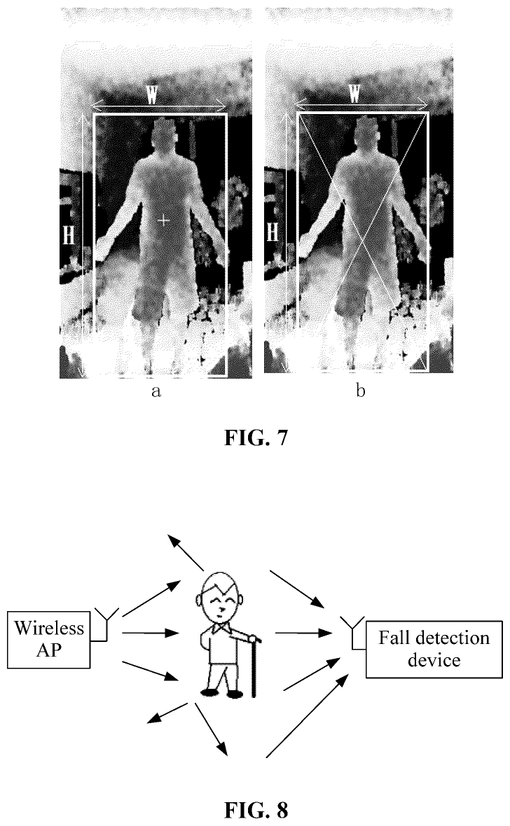

In this embodiment of the present application, the thermal imaging unit may be used for capturing the infrared thermal image of the to-be-detected target as shown in FIG. 6. Then the captured infrared thermal image is compared with the preset standard infrared thermal image in the memory to determine a center point of the infrared thermal image. The specific principle is as follows: The temperature of a thermal region formed by a human body in the infrared thermal image is higher than ambient temperature (assuming an indoor environment); therefore, a background thermal image is removed from the infrared thermal image to discover the human thermal region of the to-be-detected target as shown in FIG. 7; here the width and height of the human thermal region is W and H respectively; an intersection point of two diagonal lines of a rectangular region formed by W×H is calibrated as the center point of the infrared thermal image; finally, a ratio of a movement distance of the center point of the infrared thermal image within preset duration to the preset duration is taken as the first speed V₁. It can be judged to a certain extent through the first speed whether the to-be-detected target is in a state of, for example, normal walking, falling, standing still, or squatting. Exemplarily, if the first speed is less than a preset speed threshold, it indicates that the to-be-detected target is in a state of, for example, normal walking, standing still or squatting instead of falling. Acceleration is generated when a human falls. Therefore, if the first speed is greater than the preset speed threshold, it indicates that the to-be-detected target may be in the fall state.

In S320, the second speed of the to-be-detected target and the network packet throughput are determined according to the wireless network packet data received by the radio frequency transceiver.

In this embodiment of the present application, as shown in FIG. 4, the to-be-detected target is within a line of sight (LOS) among the wireless AP, an infrared lens, and the RF front-end circuit. The RF front-end circuit may continuously receive electromagnetic wave signals and CSI that are sent by the wireless AP. The process of determining the second speed of the to-be-detected target through the electromagnetic wave signals and the CSI is introduced hereinafter.

The to-be-detected target is within the line of sight between the wireless AP and the RF front-end circuit. Therefore, an electromagnetic wave signal sent by the wireless AP may be scattered due to the to-be-detected target and propagated through multiple paths. An electromagnetic wave scattered electric field received by the RF front-end circuit is expressed as below.

$${\vec{E}}_{j} ( t , f ) = {\int }_{4 π} \vec{F} ( θ ) \times {e}^{j \vec{h} \times {\vec{V}}_{j} t} d θ \qquad ( 3 )$$

In the formula, \vec{E}ⱼ(t,f) denotes a scattered electric field of a j-th scatterer received by the RF front-end circuit with center frequency f within the preset duration t. \vec{F}(θ) denotes an angular spectrum. \vec{h} denotes a directional wavenumber. \vec{V}ⱼ denotes the speed of the j-th scatterer.

An autocorrelation function (ACF) of the scattered electric field is expressed as below.

$${ψ}_{{\vec{E}}_{j}} ( t , f ) = \frac{〈 {\vec{E}}_{j} ( 0 , f ) , {\vec{E}}_{j} ( t , f ) 〉}{\sqrt{〈 {\vert {\vec{E}}_{j} ( 0 , f ) \vert}^{2} {\vert {\vec{E}}_{j} ( t , f ) \vert}^{2} 〉}} \qquad ( 4 )$$

The electric field is disassembled into an x-axis component of the j-th scatterer, a y-axis component of the j-th scatterer, and a z-axis component of the j-th scatterer according to the viewpoint of three dimensions. Then formula (4) may be disassembled as below.

$${ψ}_{{\vec{E}}_{jx}} ( t , f ) = {ψ}_{{\vec{E}}_{jy}} ( t , f ) = \frac{3}{2} \{ \frac{sin ( h {V}_{j} t )}{h {V}_{j} t} - \frac{1}{{( h {V}_{j} t )}^{2}} ( \frac{sin ( h {V}_{j} t )}{h {V}_{j} t} - cos ( h {V}_{j} t ) ) \} \qquad ( 5 )$$

$${ψ}_{{\vec{E}}_{jz}} ( t , f ) = \frac{3}{{( h {V}_{j} t )}^{2}} \{ \frac{sin ( h {V}_{j} t )}{h {V}_{j} t} - cos ( h {V}_{j} t ) \} \qquad ( 6 )$$

$${Ψ}_{{\vec{E}}_{jx}} ( t , f ) and {Ψ}_{{\vec{E}}_{j y}} ( t , f )$$

denote the x-axis component of the electric field of the j-th scatterer and the y-axis component of the electric field of the j-th scatterer respectively.

$${Ψ}_{{\vec{E}}_{j z}} ( t , f )$$

denotes the z-axis component of the electric field of the j-th scatterer.

It is assumed that the movement distance of the to-be-detected target within the preset duration t is that d=Vⱼt and that the wavenumber is that

$$h = \frac{2 π}{λ} ,$$

where λ denotes a wavelength. Moreover, it is assumed that the unit of distance d is λ. Then after spatial parameters are brought in formulas (5) and (6), spatial ACFs may be expressed as below.

$${ψ}_{{E}_{jx}} ( t , f ) = {ψ}_{{E}_{jy}} ( t , f ) = \frac{3}{2} \{ \frac{sin ( 2 π d )}{2 π d} - \frac{1}{{( 2 π d )}^{2}} ( \frac{sin ( 2 π d )}{2 π d} - cos ( 2 π d ) ) \} \qquad ( 7 )$$

$${ψ}_{{E}_{jz}} ( t , f ) = \frac{3}{{( 2 π d )}^{2}} \{ \frac{sin ( 2 π d )}{2 π d} - cos ( 2 π d ) \} \qquad ( 8 )$$

Ψ_{E}_{ⱼₓ}(t,f) and Ψ_{E}_{_{jy}}(t,f) denote a spatial ACF of the x-axis component of the electric field of the j-th scatterer and a spatial ACF of the y-axis component of the electric field of the j-th scatterer respectively. Ψ_{E}_{_{jz}}(t,f) denotes a spatial ACF of the z-axis component of the electric field of the j-th scatterer.

Based on the superposition principle of electric fields, it is assumed that the scattered electric field received by the RF front-end circuit is as below.

$${\vec{E}}_{r x} ( t , f ) = {\sum }_{ℓ ∈ ℏ} {\vec{E}}_{ℓ} ( t , f ) + {\sum }_{κ ∈ ϑ} {\vec{E}}_{κ} ( t , f ) \qquad ( 9 )$$

In the formula, ℏ denotes a set of static scatterers in the environment. ϑ denotes a set of dynamic scatterers in the environment. \vec{E}ₜ(t,f) denotes a received electric field of a l-th static scatterer. \vec{E}_{κ}(t,f) denotes a received electric field of a κ-th dynamic scatterer.

Then a power response of the CSI received by the RF front-end circuit may be expressed as below.

P(t,f)≙|C(t,f)|²=|\vec{E}ₙ(t,f)|²+w(t,f)=υ(t,f)+w(t,f) (10)

In the formula, P(t,f) denotes the power response of the CSI. C(t,f) denotes the CSI on a subcarrier received by the RF front-end circuit with center frequency f within the preset duration t. |C(t,f)|² denotes a square of the CSI. υ(t,f) denotes a received electric field total power. w(t,f) denotes an additive white Gaussian noise (AWGN) following a Gaussian distribution with zero mean and constant variance, that is, w(t,f)˜N(0,σ_{w}²). C(t,f) may also be expressed as below.

$$C ( t , f ) = \frac{T ( t , f )}{R ( t , f )} \qquad ( 11 )$$

In the formula, T(t,f) denotes a sent signal (sent by the wireless AP) through a subcarrier with center frequency f within the preset duration t. R(t,f) denotes a received signal (received by the RF front-end circuit) through a subcarrier with center frequency f within the preset duration t.

Formula (10) may be rewritten as below.

$$P ( t , f ) = {\vert {\sum }_{ℓ ∈ ℏ} {\vec{E}}_{ℓ} ( t , f ) + {\sum }_{κ ∈ ϑ} {\vec{E}}_{κ} ( t , f ) \vert}^{2} + w ( t , f ) = {\sum }_{ξ ∈ \{ x , y , z \}} \{ {\sum }_{ℓ ∈ ℏ} {\vert {\vec{E}}_{ℓ ξ} ( t , f ) \vert}^{2} + 2 R e [ {E}_{ℓξ}^{*} ( f ) \cdot {\sum }_{κ ∈ ϑ} {E}_{κξ} ( f ) ] + {\vert {\sum }_{κ ∈ ϑ} {E}_{κξ} ( f ) \vert}^{2} \} + w ( t , f ) \qquad ( 12 )$$

Then the autocorrelation function of the power response P(t,f) of the CSI is expressed as below.

$$A C \{ P ( \text{?} , f ) \} = cov [ P ( t , f ) , P ( \text{?} - τ , f ) ] = \sum \text{?} \{ \sum \text{?} \frac{2 {\vert \vec{E} \text{?} ( f ) \vert}^{2} E \text{?} ( f )}{3} ℤ E \text{?} ( τ , f ) + \sum \text{?} \frac{E \text{?} ( f ) E \text{?} ( f )}{9} \times ℤ E \text{?} ( t , f ) ℤ E \text{?} ( t , f ) \} + δ ( τ ) {σ}^{2} ( f ) \qquad ( 13 )$$

$$\text{?} \text{indicates text missing or illegible when filed}$$

In the formula, AC{•} denotes the autocorrelation function (ACF) of the power response P(t,f) of the CSI. cov[•] denotes convolution operation. z denotes an autocorrelation function. δ(τ) denotes a Dirac delta function.

The power variance of the received electric field may be obtained as below from formula (13).

$${σ}_{ξ}^{2} ( f ) = A C \{ P ( 0 , f ) \} = {\sum }_{ξ ∈ \{ x , y , z \}} ( {\sum }_{κ ∈ ϑ} \frac{2 {\vert {\vec{E}}_{ℓξ} ( f ) \vert}^{2} {E}_{κ}^{2} ( f )}{3} + {\sum }_{{{κ}_{1} , {κ}_{2} ∈ ϑ}_{{κ}_{1} , \geq {κ}_{2}}} \frac{{E}_{{κ}_{1}}^{2} ( f ) {E}_{{κ}_{2}}^{2} ( f )}{9} ) \qquad ( 14 )$$

Above all, the autocorrelation function (ACF) of the power response P(t,f) of the CSI may be expressed as below.

$$\begin{matrix}ℤψ ( τ ) = \frac{A C \{ P ( t , f ) \}}{σ \text{?} ( f )} \\ = \sum \text{?} ( Ω \text{?} {ℤ}^{2} E \text{?} + Ωℤ E \text{?} )\end{matrix} \qquad ( 15 )$$

$$\text{?} \text{indicates text missing or illegible when filed}$$

In the formula, Ω₁ and Ω₂ denote scale factors.

Formula (8) is a spatial ACF particular solution of the autocorrelation function (ACF) of the power response of the CSI in the z-axis component of the electric field of the j-th scatterer. If the maximum value or the minimum value is to be obtained through formula (8), formula (8) should satisfy the equation below.

$${ψ}_{{E}_{jz}} ( t , f ) = \frac{3}{{( 2 π d )}^{2}} \{ \frac{sin ( 2 π d )}{2 π d} - cos ( 2 π d ) \} = 0 \qquad ( 16 )$$

When

$$sin c ( 2 π d ) = \frac{sin ( 2 π d )}{2 π d} ,$$

then equation (16) may be rewritten as below.

$$\frac{3}{{( 2 π d )}^{2}} \{ sin c ( 2 π d ) - cos ( 2 π d ) \} = 0 \qquad ( 17 )$$

To get equation (17) established, the equation below needs to be satisfied.

$$\frac{3}{{( 2 π d )}^{2}} = 0 .$$

Alternatively, {sin c(2πd)−cos(2πd)}=0.

It can be seen that a solution of the former equation is that d tends to infinity, which does not conform to actual conditions and is discarded. A first solution of the latter equation is a particular solution of a first valley function; that is, the solution is the ACF particular solution of the j-th scatterer on the z axis.

Above all, the second speed of the to-be-detected target is determined as that V₂=ΣVⱼ. In the formula, ΣVⱼ denotes a sum of estimated speed components of the j-th scatterer in the electromagnetic field on the x axis, y axis, and z axis. The z axis is an axis of a movement direction.

The process of determining the network packet throughput through the electromagnetic wave signal is introduced hereinafter.

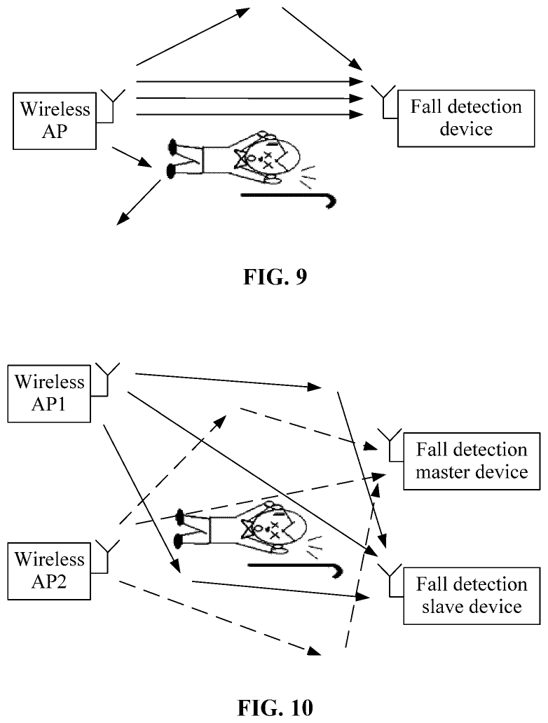

As shown in FIG. 8, the to-be-detected target is within the line of sight between the wireless AP and the RF front-end circuit of a fall detection device. The RF front-end circuit may continuously receive the network packet throughput (for example, TCP throughput or UDP throughput). An electromagnetic wave emitted by the wireless AP may be reflected, scattered and multi-path attenuated due to the obstruction of the to-be-detected target. Therefore, the network packet throughput received by the RF front-end circuit may be relatively low normally. However, when the to-be-detected target falls, as shown in FIG. 9, the obstruction of the to-be-detected target to the electromagnetic wave decreases suddenly. Therefore, the network packet throughput received by the RF front-end circuit may vary from low to high suddenly. On this basis, it can be judged whether the to-be-detected target falls. In order to expand a fall detection range, a plurality of fall detection systems may be set in a preset space (such as, an indoor space). The fall detection systems include wireless access points (sending ends) and fall detection device (receiving ends). As shown in FIG. 10, by way of example, two wireless access points (wireless AP1 and wireless AP2) and two fall detection devices (a fall detection master device and a fall detection slave device) are provided. The fall detection master device establishes a communication link with wireless AP2. The fall detection slave device establishes a communication link with wireless AP1. Moreover, in order to avoid the effect of co-channel interference, wireless AP1 may be connected via WLAN 2.4 G, and wireless AP2 may be connected via WLAN 5G.

In S330, the detection result of the fall state of the to-be-detected target is generated and determined according to the first speed, the second speed, and the network packet throughput.

In this embodiment of the present application, if the first speed and the second speed are each greater than the preconfigured preset speed threshold V_{w}, and if the network packet throughput varies from low to high, the detection result that the to-be-detected target is in the fall state will be determined. Moreover, the buzzer may be controlled to sound an alarm to prompt the occurrence of a fall event. If the first speed and/or the second speed is less than the preconfigured preset speed threshold V., and if the network packet throughput of the wireless network packet data collected by the radio frequency transceiver within the preset duration varies from low to high, a detection result that the to-be-detected target is in a sitting or squatting state will be determined. Moreover, when the first speed and the second speed are each greater than the preset speed threshold V., and when the network packet throughput does not vary from low to high, it indicates that the preset speed threshold previously preconfigured is no longer accurate. In this case, the movement speed of the to-be-detected target needs to be re-observed so as to correct the preset speed threshold.

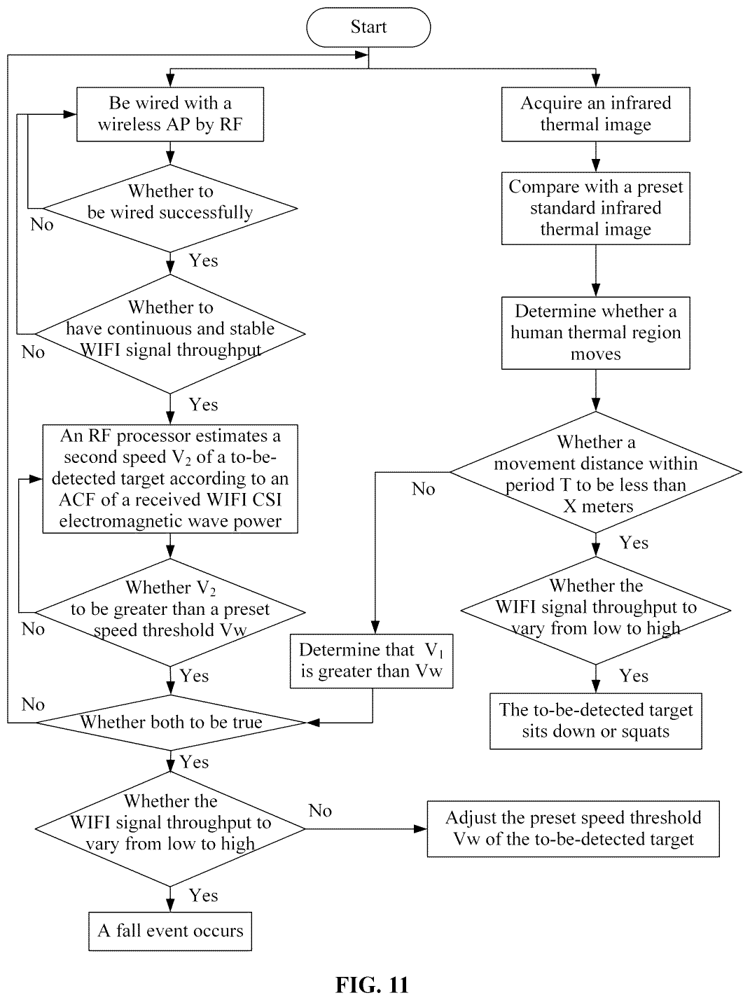

FIG. 11 is a flowchart of another fall detection method according to the embodiment of the present application. As shown in FIG. 11, the fall detection method is a further refinement of the fall detection method shown in FIG. 5. The specific implementation process is similar to the preceding process and is not described here.

For technical solutions in this embodiment of the present application, the first speed of the to-be-detected target is determined according to the infrared thermal image captured by the thermal imaging unit; the second speed of the to-be-detected target and the network packet throughput are determined according to the wireless network packet data received by the radio frequency transceiver; and the detection result of the fall state of the to-be-detected target is generated and determined according to the first speed, the second speed, and the network packet throughput. This embodiment of the present application can improve the accuracy of the fall detection result and reduce the cost of a fall detection of the to-be-detected target. Moreover, the computational complexity is relatively low; that is, the detection efficiency is relatively high.

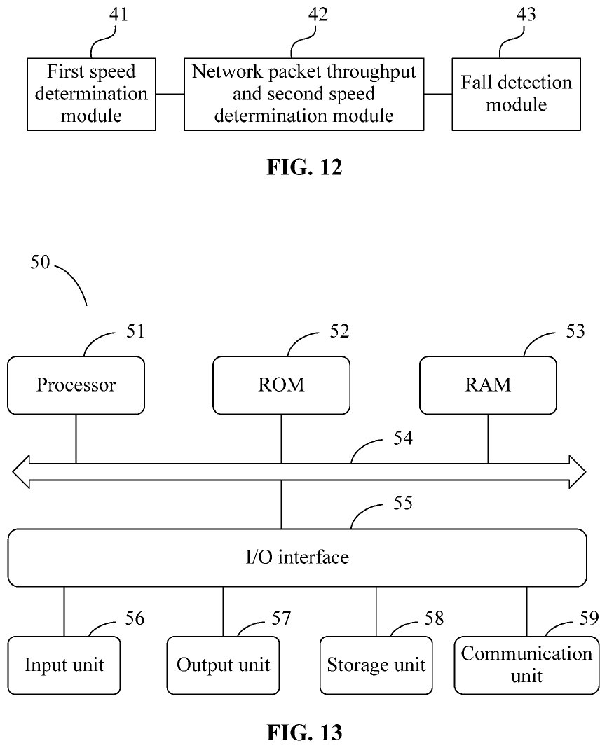

FIG. 12 is a structural diagram of a fall detection apparatus according to another embodiment of the present application. As shown in FIG. 12, the apparatus is applied to a fall detection system. The fall detection system includes a thermal imaging unit, a radio frequency transceiver, and a wireless access point. The apparatus includes a first speed determination module 41, a network packet throughput and second speed determination module 42, and a fall detection module 43.

The first speed determination module 41 is configured to determine a first speed of the to-be-detected target according to an infrared thermal image of a to-be-detected target captured by the thermal imaging unit within preset duration.

The network packet throughput and second speed determination module 42 is configured to determine network packet throughput and a second speed of the to-be-detected target according to wireless network packet data transmitted by the wireless access point and collected by the radio frequency transceiver within the preset duration.

The fall detection module 43 is configured to generate and determine a detection result of a fall state of the to-be-detected target according to the first speed, the second speed, and the network packet throughput.

For technical solutions in this embodiment of the present application, the first speed determination module determines the first speed of the to-be-detected target according to the infrared thermal image of the to-be-detected target within the preset duration; the network packet throughput and second speed determination module determines the network packet throughput and the second speed of the to-be-detected target according to the wireless network packet data; and the fall detection module generates and determines the detection result of the fall state of the to-be-detected target according to the first speed, the second speed, and the network packet throughput. In this embodiment of the present application, the first speed of the to-be-detected target is determined according to the infrared thermal image. The network packet throughput and the second speed of the to-be-detected target are determined according to the wireless network packet data. The fall detection result of the to-be-detected target is then determined comprehensively according to the first speed, the second speed, and the network packet throughput, improving the accuracy of the fall detection result and reducing the cost of a fall detection.

On the basis of the preceding embodiments of the present application, the first speed determination module 41 includes a center point determination unit and a first speed determination unit.

The center point determination unit is configured to compare an infrared thermal image with a preset standard infrared thermal image to determine a center point of the infrared thermal image.

The first speed determination unit is configured to take a ratio of a movement distance of the center point of the infrared thermal image within the preset duration to the preset duration as the first speed.

On the basis of the preceding embodiments of the present application, the network packet throughput and second speed determination module 42 includes a network packet throughput determination unit, a received data determination unit, a power response determination unit, an autocorrelation function determination unit, a spatial distance determination unit, and a second speed determination unit.

The network packet throughput determination unit is configured to take a data amount of the wireless network packet data within the preset duration as the network packet throughput.

The received data determination unit is configured to determine a received electric field total power and channel state information that are in the wireless network packet data.

The power response determination unit is configured to take a sum of the received electric field total power and a power of a white Gaussian noise a power response of the channel state information.

The autocorrelation function determination unit is configured to determine an autocorrelation function corresponding to the power response of the channel state information.

The spatial distance determination unit is configured to take an abscissa of a first local valley value of the autocorrelation function as a spatial distance. The spatial distance is a movement distance of the to-be-detected target within the preset duration. The spatial distance is measured in wavelengths.

The second speed determination unit is configured to take a ratio of the spatial distance to the preset duration as the second speed.

On the basis of the preceding embodiments of the present application, the autocorrelation function corresponding to the power response of the channel state information is expressed as below.

$$ℤψ ( τ ) = \sum \text{?} ( Ω \text{?} {ℤ}^{2} E \text{?} + Ωℤ E \text{?} )$$

$$\text{?} \text{indicates text missing or illegible when filed}$$

[symbol] ψ(t) denotes the autocorrelation function corresponding to the power response of the channel state information. t denotes the preset duration. Ω₁ and Ω₂ denote scale factors. E_{R} denotes a scattered electric field of a j-th scatterer received by the fall detection system in x-axis, y-axis and z-axis directions. [symbol] E_{jξ} denotes an autocorrelation function corresponding to the scattering electric field.

On the basis of the preceding embodiments of the present application, the fall detection module 43 includes a fall state determination unit.

The fall state determination unit is configured to, if the first speed and the second speed are each greater than a preset speed threshold, and if the network packet throughput varies from low to high, determine the detection result that the to-be-detected target is in the fall state.

On the basis of the preceding embodiments of the present application, the apparatus further includes a threshold correction unit.

The threshold correction unit is configured to, if the first speed and the second speed are each greater than the preset speed threshold, and if the network packet throughput does not vary from low to high, correct the preset speed threshold.

On the basis of the preceding embodiments of the present application, the apparatus further includes an alarm unit.

The alarm unit is configured to, when the detection result is that the to-be-detected target is in the fall state, control a buzzer to sound an alarm.

The fall detection apparatus according to this embodiment of the present application may perform the fall detection method according to any embodiment of the present application and has functional units and beneficial effects corresponding to the performed method.

FIG. 13 is a structural diagram of an electronic device 50 for implementing embodiments of the present application. The electronic device is intended to represent various forms of digital computers, for example, a laptop computer, a desktop computer, a worktable, a personal digital assistant, a server, a blade server, a mainframe computer, or an applicable computer. The electronic device may also represent various forms of mobile apparatuses, for example, a personal digital assistant, a cellphone, a smartphone, a wearable device (such as a helmet, glasses, and a watch), or a similar computing apparatus. Herein the shown components, the connections and relationships between these components, and the functions of these components are illustrative only and are not intended to limit the implementation of the present application as described and/or claimed herein.

As shown in FIG. 13, the electronic device 50 includes at least one processor 51 and a memory (such as a read-only memory (ROM) 52 and a random-access memory (RAM) 53) communicatively connected to the at least one processor 51. The memory stores a computer program executable by the at least one processor. A processor 51 may perform various types of appropriate operations and processing according to a computer program stored in a ROM 52 or a computer program loaded from a storage unit 58 to a RAM 53. Various programs and data required for the operation of the electronic device 50 are also stored in the RAM 53. The processor 51, the ROM 52, and the RAM 53 are connected to each other through a bus 54. An input/output (I/O) interface 55 is also connected to the bus 54.

Multiple components in the electronic device 50 are connected to the I/O interface 55. The multiple components include an input unit 56 such as a keyboard or a mouse, an output unit 57 such as various types of displays or speakers, the storage unit 58 such as a magnetic disk or an optical disk, and a communication unit 59 such as a network card, a modem or a wireless communication transceiver. The communication unit 59 allows the electronic device 50 to exchange information/data with other devices over a computer network such as the Internet and/or various telecommunications networks.

The processor 51 may be various general-purpose and/or special-purpose processing components having processing and computing capabilities. Examples of the processor 51 include, but are not limited to, a central processing unit (CPU), a graphics processing unit (GPU), a special-purpose artificial intelligence (AI) computing chip, a processor executing machine learning models and algorithms, a digital signal processor (DSP), and any appropriate processor, controller and microcontroller. The processor 51 performs various preceding methods and processing, such as the fall detection method.

In some examples, the fall detection method may be implemented as computer programs tangibly contained in a computer-readable storage medium such as the storage unit 58. In some embodiments, part or all of computer programs may be loaded and/or installed onto the electronic device 50 via the ROM 52 and/or the communication unit 59. When the computer programs are loaded to the RAM 53 and executed by the processor 51, one or more steps of the preceding fall detection method may be performed. Alternatively, in other embodiments, the processor 51 may be configured, in any other suitable manner (for example, by means of firmware), to perform the fall detection method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. These embodiments may include implementations in one or more computer programs. The one or more computer programs may be executable and/or interpretable on a programmable system including at least one programmable processor. A programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Computer programs for implementation of the methods of the present application may be written in one programming language or any combination of multiple programming languages. These computer programs may be provided for a processor of a general-purpose computer, a special-purpose computer or another programmable data processing apparatus such that the computer programs, when executed by the processor, cause functions/operations specified in the flowcharts and/or block diagrams to be implemented. These computer programs may be executed entirely on a machine, partly on a machine, as a stand-alone software package, partly on a machine and partly on a remote machine, or entirely on a remote machine or a server.

In the context of the present disclosure, the computer-readable storage medium may be a tangible medium including or storing a computer program that is used by or used in conjunction with an instruction execution system, apparatus or device. The computer-readable storage medium may include, but is not limited to, an electronic, magnetic, optical, electromagnetic, infrared or semiconductor system, apparatus or device, or any suitable combination thereof. Alternatively, the computer-readable storage medium may be a machine-readable signal medium.

Concrete examples of the machine-readable storage medium include an electrical connection based on one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on the electronic device. The electronic device has a display device (for example, a cathode-ray tube (CRT) or a liquid-crystal display (LCD) monitor) for displaying information to the user; and a keyboard and a pointing device (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a user computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network, and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related VPS service.

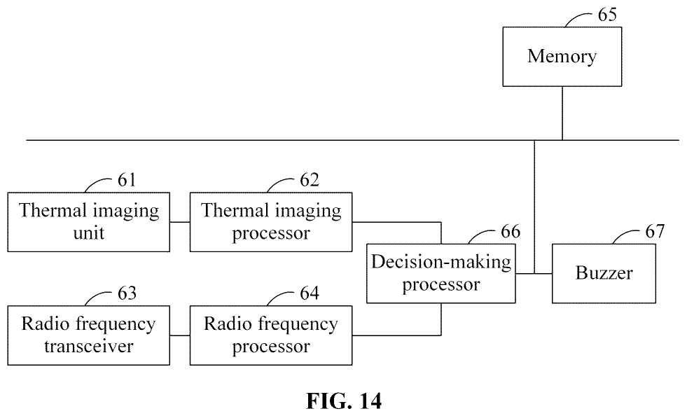

FIG. 14 is a structural diagram of a fall detection device according to another embodiment of the present application. As shown in FIG. 14, the fall detection device includes a thermal imaging unit 61, a thermal imaging processor 62, a radio frequency transceiver 63, a radio frequency processor 64, a storage 65, a decision-making processor 66, and a buzzer 67. The thermal imaging unit 61 is configured to collect an infrared thermal image of a to-be-detected target and send the infrared thermal image to the thermal imaging processor. The thermal imaging unit 61 may include a lens assembly and a complementary metal-oxide semiconductor (CMOS) sensor.

The thermal imaging processor 62 is configured to receive the infrared thermal image and determine a first speed of the to-be-detected target according to the infrared thermal image.

The radio frequency transceiver 63 is configured to collect wireless network packet data transmitted by a wireless access point and send the wireless network packet data to the radio frequency processor. The radio frequency transceiver 63 may include an RF front-end circuit and an RF transceiver circuit.

The radio frequency processor 64 is configured to receive the wireless network packet data and determine network packet throughput and a second speed of the to-be-detected target according to the wireless network packet data.

The memory 65 is configured to store a preset standard infrared thermal image of the to-be-detected target.

The decision-making processor 66 is configured to generate and determine a detection result of a fall state of the to-be-detected target according to the first speed, the second speed, and the network packet throughput.

The buzzer 67 is configured to sound an alarm when the detection result is that the to-be-detected target is in the fall state.

It is to be understood that various forms of the preceding flows may be used with steps reordered, added, or deleted. For example, the steps described in the present application may be performed in parallel, in sequence, or in a different order as long as the desired result of the technical solutions provided in the present application can be achieved. The execution sequence of these steps is not limited herein.

What is claimed is:

1. A fall detection method, wherein the method is applied to a fall detection system comprising a thermal imaging unit, a radio frequency transceiver, and a wireless access point and comprises:
determining a first speed of a to-be-detected target according to an infrared thermal image of the to-be-detected target captured by the thermal imaging unit within preset duration;
determining network packet throughput and a second speed of the to-be-detected target according to wireless network packet data transmitted by the wireless access point and collected by the radio frequency transceiver within the preset duration; and
generating and determining a detection result of a fall state of the to-be-detected target according to the first speed, the second speed, and the network packet throughput.

2. The method according to claim 1, wherein determining the first speed of the to-be-detected target according to the infrared thermal image of the to-be-detected target captured by the thermal imaging unit within preset duration comprises:
comparing the infrared thermal image with a preset standard infrared thermal image to determine a center point of the infrared thermal image; and
taking a ratio of a movement distance of the center point of the infrared thermal image within the preset duration to the preset duration as the first speed.

3. The method according to claim 1, wherein determining the network packet throughput and the second speed of the to-be-detected target according to the wireless network packet data transmitted by the wireless access point and collected by the radio frequency transceiver within the preset duration comprises:
taking a data amount of the wireless network packet data within the preset duration as the network packet throughput;
determining a received electric field total power and channel state information that are in the wireless network packet data;
taking a sum of the received electric field total power and a power of a white Gaussian noise as a power response of the channel state information;
determining an autocorrelation function corresponding to the power response of the channel state information;
taking an abscissa of a first local valley value of the autocorrelation function as a spatial distance, wherein the spatial distance is a movement distance of the to-be-detected target within the preset duration, and the spatial distance is measured in wavelengths; and
taking a ratio of the spatial distance to the preset duration as the second speed.

4. The method according to claim 3, wherein the autocorrelation function is expressed as follows:
$$ℤψ ( τ ) = \sum \text{?} ( Ω \text{?} {ℤ}^{2} E \text{?} + Ωℤ E \text{?} )$$
$$\text{?} \text{indicates text missing or illegible when filed}$$
wherein [symbol] Ψ(t) denotes the autocorrelation function, t denotes the preset, Ω₁ and Ω₂ denote scale factors, Σ_{jξ} denotes a scattered electric field of a j-th scatterer received by the fall detection system in x-axis, y-axis and z-axis directions, and [symbol] E_{jξ} denotes an autocorrelation function corresponding to the scattered electric field.

5. The method according to claim 1, wherein generating and determining the detection result of the fall state of the to-be-detected target according to the first speed, the second speed, and the network packet throughput comprises:
in response to the first speed and the second speed each being greater than a preset speed threshold and the network packet throughput varying from low to high, determining that the detection result is that the to-be-detected target is in the fall state.

6. The method according to claim 5, further comprising:
in response to the first speed and the second speed each being greater than the preset speed threshold and the network packet throughput not varying from low to high, correcting the preset speed threshold.

7. The method according to claim 1, further comprising:
in response to the detection result being that the to-be-detected target is in the fall state, controlling a buzzer to sound an alarm.

8. An electronic device, comprising:
at least one processor; and
a memory communicatively connected to the at least one processor,
wherein the memory stores a computer program executable by the at least one processor, and the computer program is executed by the at least one processor to cause the at least one processor to perform:
determining a first speed of a to-be-detected target according to an infrared thermal image of the to-be-detected target captured by the thermal imaging unit within preset duration;
determining network packet throughput and a second speed of the to-be-detected target according to wireless network packet data transmitted by the wireless access point and collected by the radio frequency transceiver within the preset duration; and
generating and determining a detection result of a fall state of the to-be-detected target according to the first speed, the second speed, and the network packet throughput.

9. The electronic device according to claim 8, wherein the at least one processor is configured to determine the first speed of the to-be-detected target according to the infrared thermal image of the to-be-detected target captured by the thermal imaging unit within preset duration by:
comparing the infrared thermal image with a preset standard infrared thermal image to determine a center point of the infrared thermal image; and
taking a ratio of a movement distance of the center point of the infrared thermal image within the preset duration to the preset duration as the first speed.

10. The electronic device according to claim 8, wherein the at least one processor is configured to determine the network packet throughput and the second speed of the to-be-detected target according to the wireless network packet data transmitted by the wireless access point and collected by the radio frequency transceiver within the preset duration by:
taking a data amount of the wireless network packet data within the preset duration as the network packet throughput;
determining a received electric field total power and channel state information that are in the wireless network packet data;
taking a sum of the received electric field total power and a power of a white Gaussian noise as a power response of the channel state information;
determining an autocorrelation function corresponding to the power response of the channel state information;
taking an abscissa of a first local valley value of the autocorrelation function as a spatial distance, wherein the spatial distance is a movement distance of the to-be-detected target within the preset duration, and the spatial distance is measured in wavelengths; and
taking a ratio of the spatial distance to the preset duration as the second speed.

11. The electronic device according to claim 10, wherein the autocorrelation function is expressed as follows:
$$ℤψ ( τ ) = \sum \text{?} ( Ω \text{?} {ℤ}^{2} E \text{?} + Ωℤ E \text{?} )$$
$$\text{?} \text{indicates text missing or illegible when filed}$$
wherein [symbol] Ψ(t) denotes the autocorrelation function, t denotes the preset, Ω₁ and Ω₂ denote scale factors, E_{jξ} denotes a scattered electric field of a j-th scatterer received by the fall detection system in x-axis, y-axis and z-axis directions, and [symbol] E_{jξ} denotes an autocorrelation function corresponding to the scattered electric field.

12. The electronic device according to claim 8, wherein the at least one processor is configured to generate and determine the detection result of the fall state of the to-be-detected target according to the first speed, the second speed, and the network packet throughput by:
in response to the first speed and the second speed each being greater than a preset speed threshold and the network packet throughput varying from low to high, determining that the detection result is that the to-be-detected target is in the fall state.

13. The electronic device according to claim 12, wherein the at least one processor is further configured to perform:
in response to the first speed and the second speed each being greater than the preset speed threshold and the network packet throughput not varying from low to high, correcting the preset speed threshold.

14. The electronic device according to claim 8, wherein the at least one processor is further configured to perform:
in response to the detection result being that the to-be-detected target is in the fall state, controlling a buzzer to sound an alarm.

15. A non-transitory computer-readable storage medium for storing a computer instruction, wherein when executed by a processor, the computer instruction is configured to perform:
determining a first speed of a to-be-detected target according to an infrared thermal image of the to-be-detected target captured by the thermal imaging unit within preset duration;
determining network packet throughput and a second speed of the to-be-detected target according to wireless network packet data transmitted by the wireless access point and collected by the radio frequency transceiver within the preset duration; and
generating and determining a detection result of a fall state of the to-be-detected target according to the first speed, the second speed, and the network packet throughput.

16. The non-transitory computer-readable storage medium according to claim 15, wherein the computer instruction is configured to determine the first speed of the to-be-detected target according to the infrared thermal image of the to-be-detected target captured by the thermal imaging unit within preset duration by:
comparing the infrared thermal image with a preset standard infrared thermal image to determine a center point of the infrared thermal image; and
taking a ratio of a movement distance of the center point of the infrared thermal image within the preset duration to the preset duration as the first speed.

17. The non-transitory computer-readable storage medium according to claim 15, wherein the computer instruction is configured to determine the network packet throughput and the second speed of the to-be-detected target according to the wireless network packet data transmitted by the wireless access point and collected by the radio frequency transceiver within the preset duration by:
taking a data amount of the wireless network packet data within the preset duration as the network packet throughput;
determining a received electric field total power and channel state information that are in the wireless network packet data;
taking a sum of the received electric field total power and a power of a white Gaussian noise as a power response of the channel state information;
determining an autocorrelation function corresponding to the power response of the channel state information;
taking an abscissa of a first local valley value of the autocorrelation function as a spatial distance, wherein the spatial distance is a movement distance of the to-be-detected target within the preset duration, and the spatial distance is measured in wavelengths; and
taking a ratio of the spatial distance to the preset duration as the second speed.

18. The non-transitory computer-readable storage medium according to claim 17, wherein the autocorrelation function is expressed as follows:
$$ℤψ ( τ ) = \sum \text{?} ( Ω \text{?} {ℤ}^{2} E \text{?} + Ωℤ E \text{?} )$$
$$\text{?} \text{indicates text missing or illegible when filed}$$
wherein [symbol] Ψ(t) denotes the autocorrelation function, t denotes the preset, Ω₁ and Ω₂ denote scale factors, E_{jξ} denotes a scattered electric field of a j-th scatterer received by the fall detection system in x-axis, y-axis and z-axis directions, and [symbol] E_{jξ} denotes an autocorrelation function corresponding to the scattered electric field.

19. The non-transitory computer-readable storage medium according to claim 15, wherein the computer instruction is configured to generate and determine the detection result of the fall state of the to-be-detected target according to the first speed, the second speed, and the network packet throughput by:
in response to the first speed and the second speed each being greater than a preset speed threshold and the network packet throughput varying from low to high, determining that the detection result is that the to-be-detected target is in the fall state.

20. The non-transitory computer-readable storage medium according to claim 19, wherein the computer instruction is further configured to perform:
in response to the first speed and the second speed each being greater than the preset speed threshold and the network packet throughput not varying from low to high, correcting the preset speed threshold.
